(19) United States
(12) Patent Application Publication
(10) Pub. No.: US 2023/0410146 A1
(43) Pub. Date: Dec. 21, 2023

(54) SYSTEM AND METHOD FOR OPTIMIZING MEDIA TARGETING IN DIGITAL ADVERTISEMENT USING DYNAMIC CATEGORIES

(71) Applicant: P39 Tech LLC, New York, NY (US)

(72) Inventors: Jonathan SCHLER, Petach Tikwa (IL); Alex WHITE, New Rochelle, NY (US)

(73) Assignee: P39 Tech LLC, New York, NY (US)

(21) Appl. No.: 17/807,267

(22) Filed: Jun. 16, 2022

(51) Int. Cl. G06Q 30/02; H04N 21/81

(52) U.S. Cl. CPC G06Q 30/0251; G06Q 30/0277; G06Q 30/0242; G06Q 30/0275; H04N 21/812

(57) ABSTRACT

A system and method for optimizing media targeting for placement of digital advertisements. The method includes creating, based on a performance goal and historical data, a first dynamic category version that includes at least one category attribute; identifying at least one first matching advertisement (ad) request based on the first dynamic category version, wherein the at least one first matching ad request is bid on for placement of advertisements; in response to the placement of advertisements, gathering feedback data on performance of served advertisements; identifying, based on the gathered feedback data, at least one potential category attribute; updating the first dynamic category version to create a second dynamic category version based on a portion of the identified at least one potential category attribute; and identifying at least one second matching ad request for bidding based on the second dynamic category version.

### TECHNICAL FIELD

The present disclosure generally relates to digital advertising, more specifically to the system and method for optimizing the targeting of digital media via dynamic categories.

### BACKGROUND

As computers, smartphones, and other internet-equipped devices become increasingly common in daily life, the users of such devices represent a growing segment of the market for advertisement. Digital advertising provides retailers, service providers, and other parties interested in advertising with the opportunity to reach audiences not previously available. Digital advertisements may be presented through various avenues including, for example and without limitation, internet advertisements (ads), mobile device ads, smart device ads, connected TV's, smart home devices, and the like. Digital advertising, in addition to offering advertisers greater reach than the same advertisers may enjoy through print, radio, or television ads, also offers advertisers greater flexibility in ad placement. Specifically, digital advertising provides for a greater degree of accuracy in ad targeting than may be achievable through conventional advertising means.

As digital advertising may be sold on a per-view or per-click basis, or the like, advertisements (ads) which are improperly targeted may result in low engagement or performance, while also causing advertisers to accrue high expenses. As a result, advertisers may wish to refine their targeting to reach specific market segments, such as young people, people with specific hobbies or interests, and the like, to better reach the target demographic. Contextual category targeting is an approach that enables such targeting by selecting certain categories and parameters of a website that may be relevant to the advertisement and the target demographic.

A certain category can be selected according to the advertisement's campaign goals and target market segment. However, with the vast number of categories and associated parameters, such as keywords, quality, and more, the initially selected category and associated parameters may not allow best placement of the ads. Thus, modification of the initially selected category and their elements are desired.

Performance of digital ads can be measured using different performance parameters such as visits, conversion rates, clicks, and the like. Although such performance parameters provide some indication of the performance of the advertisement campaign, performance analysis based on such parameters is limited to the information provided by the demand-side platform (DSP) and provides only a general effectiveness of the digital ads. In this case, the performance of the ads, and specifically the effectiveness of the targeted advertisements based on contextual category targeting remains unknown to result in undesired loss of expenses and resources. In this regard, while category targeting provides for the placement of ads according to selected categories that target “presumable” market segments, room for improvements still exists.

Currently, there is no feedback to correlate between display pages that ads are displayed on and the performance of the ads on those pages, and as such, there is no way to optimize the media to improve the performance of the ad. One reason for such deficiency is that there is no way to receive feedback at the URL level, that is, specific to the page that an ad is served. And even if there is the ability to see reporting by the URL, there is no way to use it to optimize the media fast enough. This is because, most people don't have the ability to understand the URL, and moreover, targeting by the URL is flawed in that new pages are introduced at a rapid pace, so by the time action is taken, the page (i.e., targeted URL) is not as relevant.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for optimizing media targeting for placement of digital advertisements. The method comprises: creating, based on a performance goal and historical data, a first dynamic category version, wherein the first dynamic category version includes at least one category attribute; identifying at least one first matching advertisement (ad) request based on the first dynamic category version, wherein the at least one first matching ad request is determined by matching the category attributes of the first dynamic category version and category attributes of the at least one first ad request, wherein the at least one first matching ad request is bid on for placement of advertisements; in response to the placement of advertisements, gathering feedback data on performance of served advertisements; identifying, based on the gathered feedback data, at least one potential category attribute; updating the first dynamic category version to create a second dynamic category version based on a portion of the identified at least one potential category attribute; and identifying at least one second matching ad request for bidding, wherein the at least one second matching ad request is determined based on the second dynamic category version.

Certain embodiments disclosed herein also include a non-transitory computer readable medium having stored thereon causing a processing circuitry to execute a process, the process comprising: creating, based on a performance goal and historical data, a first dynamic category version, wherein the first dynamic category version includes at least one category attribute; identifying at least one first matching advertisement (ad) request based on the first dynamic category version, wherein the at least one first matching ad request is determined by matching the category attributes of the first dynamic category version and category attributes of the at least one first ad request, wherein the at least one first matching ad request is bid on for placement of advertisements; in response to the placement of advertisements, gathering feedback data on performance of served advertisements; identifying, based on the gathered feedback data, at least one potential category attribute; updating the first dynamic category version to create a second dynamic category version based on a portion of the identified at least one potential category attribute; and identifying at least one second matching ad request for bidding, wherein the at least one second matching ad request is determined based on the second dynamic category version.

Certain embodiments disclosed herein also include a system for optimizing media targeting for placement of digital advertisements. The system comprises: a processing circuitry; and a memory, the memory containing instructions that, when executed by the processing circuitry, configure the system to: create, based on a performance goal and historical data, a first dynamic category version, wherein the first dynamic category version includes at least one category attribute; identify at least one first matching advertisement (ad) request based on the first dynamic category version, wherein the at least one first matching ad request is determined by matching the category attributes of the first dynamic category version and category attributes of the at least one first ad request, wherein the at least one first matching ad request is bid on for placement of advertisements; in response to the placement of advertisements, gather feedback data on performance of served advertisements; identify, based on the gathered feedback data, at least one potential category attribute; update the first dynamic category version to create a second dynamic category version based on a portion of the identified at least one potential category attribute; and identify at least one second matching ad request for bidding, wherein the at least one second matching ad request is determined based on the second dynamic category version.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for optimizing media targeting for digital advertisements according to an embodiment.

FIG. 3 is a schematic diagram illustrating update of a dynamic category and respective category attributes for optimized media targeting according to an example embodiment.

FIG. 4 is a schematic diagram of an optimization system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments present a system and method for optimizing media targeting in digital advertisements (ads) using a continuous process. The continuous process, as disclosed, enables discovery of variables or category attributes present on the page or in the environment the ad is being displayed in, which can be utilized to improve the effectiveness of digital ad placement in real-time or near real-time. In an embodiment, a tag can be employed (through incorporation) into the advertiser creative, delivered to a webpage or similar digital environment (app, connected TV, digital out-of-home device, etc.) to capture environmental signals, and potential interactions associated with the digital ad and its environment and provide as raw feedback data.

In an embodiment, the feedback data enabled by the tag can include URL or App level data regarding the page, app, or environment on which the digital ad is presented. Such rich feedback data, which can include URL specific performance data, enables close monitoring of ad performance with respect to category attributes such as, but not limited to, type of page, brand safety and suitability, page signal, time, location, and the like. The disclosed embodiments create dynamic category versions for one or more dynamic categories to facilitate identifying, updating, and tracking of specific category attributes until optimized media targeting is achieved for ad placement and the advertising campaign.

According to the disclosed embodiments, a dynamic category version may be defined by category attributes, which may be updated and modified for the dynamic category (or virtual category). The changing definitions of the dynamic category, based on different dynamic category versions, are utilized in order to allow an advertiser to accurately and effectively bid on the placement of advertisements (ads). The definitions of the dynamic category can be modified based on the performance feedback from the advertiser and each change is stored and represented in a new version of the dynamic category. It should be noted that new versions of the dynamic category that include modified category attributes are different versions of the same dynamic category. That is, the name and identification (ID) of the dynamic category stay consistent regardless of the dynamic category version that is implemented. In an embodiment, the advertiser uses such dynamic category identifiers (e.g., name, ID, and more) for bidding and buying of targeted media. To this end, such dynamic modification and updating of dynamic category definitions based on performance goals and a feedback loop enable unique optimization for enhanced performance. It should also be noted that the advertiser uses one dynamic category for any unique performance goal, creative, campaign, targeting tactic, and more.

While conventional methods allow optimization of media by analyzing the overall effectiveness of the advertising campaign, ad groups within a campaign, or by creative, it is usually limited to aggregated feedback data provided by the demand-side platform (DSP). The disclosed embodiments, however, uncover page-specific and other environmental data as well as raw performance data, including URL data, of the ad displayed on the page. Such detailed information enables refined targeting through fine tuning of various category attributes to improve advertising performance through more accuracy and efficiency that were not otherwise possible using conventional methods. It should be noted that improved media targeting allows for more accurate ad placements to increase individual user engagement and interactions with digital advertisements. To this end, optimization allows reduced processing time for advertisers and thus, improves computational efficiency and utilization of resources for bidding on ad requests for digital advertisement campaigns.

Moreover, the disclosed embodiments allow rapid automated analyses and thus, rapid optimization of targeted media for digital ad placement in real-time or near real-time, through a feedback loop, that can correlate the performance data of ads to specific category attributes. More specifically, no manual intervention is required to reduce processing time and increase efficiency in optimization. To further emphasize, digital ads are placed within micro-seconds while the number of ad requests to be served are millions per second. Thus, the real-time optimization disclosed according to the embodiments herein cannot be performed manually within the same time frame.

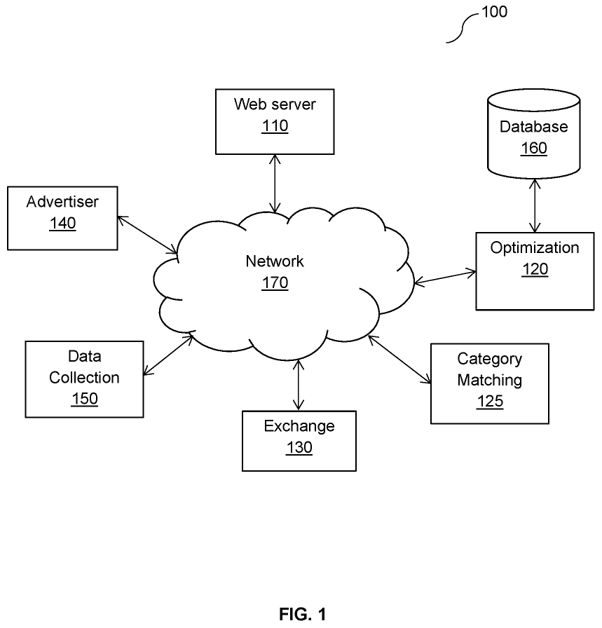

FIG. 1 is an example network diagram depicting a network system 100 utilized to describe the various disclosed embodiments for optimizing media targeting for ad placement. The depicted network diagram 100 includes a web server 110, an optimization system 120, a category matching system 125, an exchange platform 130, an advertiser 140, and a data collection system 150. Further, as depicted, the optimization system 120 is connected to a database 160.

It may be understood that the components and configuration described with respect to FIG. 1 are so provided for purposes of exemplary illustration and that other, like, components, and combinations or configurations thereof, may be likewise applicable to the embodiments disclosed herein without loss of generality or departure from the scope of the disclosure.

The various components discussed with reference to FIG. 1 are connected through a network 170. Such networks may include, as examples and without limitation, wireless, cellular, or wired networks, local area networks (LANs), wide area networks (WANs), metro area networks (MANs), the Internet, the worldwide web (WWW), similar networks, and any combination thereof. The network 170 may be a full-physical network, including exclusively physical hardware, a fully-virtual network, including only simulated or otherwise virtualized components, or a hybrid physical-virtual network, including both physical and virtualized components. Further, the network may be configured to encrypt data, both at rest and in motion, and to transmit encrypted, unencrypted, or partially-encrypted data.

The network 170 may be configured to connect to the various components of the system via wireless means such as Bluetooth (tm), long-term evolution (LTE), Wi-Fi, other, like, wireless means, and any combination thereof, via wired means such as, as examples and without limitation, Ethernet, universal serial bus (USB), other, like, wired means, and any combination thereof. Further, the network 170 may be configured to connect with the various components of the system via any combination of wired and wireless means.

The web server 110 is a web server, content delivery network (CDN), or the like, configured to provide website visitors with website content. In some embodiments, the content is delivered via the web server 110, while the actual advertisement is delivered using an ad server. Thus, hereinafter to the term web server 110 should be understood as composing both elements, the content server, and the ad server. The web server 110 may be implemented as a physical device, a system, component, or the like, as a virtual device, system, component, or the like, or in a hybrid physical-virtual implementation. The web server 110 may be connected to the optimization system 120 and the exchange platform 130, over the network 170.

The web server 110 may be configured to respond to a user's website access request by generating an ad request and serving webpages (or other content) to the user device (not shown). Webpages (also referred to as pages) are typically processed and displayed over web browsers or mobile applications (apps). The served pages may include one or more advertisements (ads). An ad may include, without limitation, a multimedia element, such as an image, text, video, audio, and the like, or any combination thereof.

The ads are served by the web server 110. The exchange platform 130, which may be different from the web server 110, is configured to process what ad is served on a specific page, on a, for example, web browser, mobile application (app), connected TV (CTV), or the like. Specifically, the web server 110 may be configured to transmit an ad request to the exchange platform 130, and to receive, from the exchange platform 130, an ad of the determined winning bid of an advertiser 140. An advertisement data feature to be presented, by inclusion as a website content data feature, may be provided by an exchange platform 130. The transaction between the web server 110 and the exchange platform 130, may be sufficiently rapid to provide for real-time or near-real-time bidding on an ad placement based on the transmitted ad requests.

An ad request, initiated by the web server 110, is a data feature including one or more descriptors or data points relevant to the page provided by the web server 110 in response to the user's access request, as well as various attributes (e.g., category attributes) of the access request. The generated ad request may include, as examples and without limitation, the uniform resource locator (URL) of the requested webpage, a user internet protocol (IP) address (or location descriptor), a timestamp, or other configuration, and the like. In an embodiment, the ad requests may be observed at the optimization system 120 to identify specific ad requests based on the targeted dynamic category. In further embodiment, the ad requests may be matched with the targeted dynamic category at the category matching system 125 for such identification. As an example, an ad request generated for a visitor to a sports news website may include descriptors or data points providing the URL of the sports news website, or a specific requested page thereof, the user location from which the user generated the webpage access request, the time the user was on the webpage, and the like.

The optimization system 120 is a device, component, system, or the like, configured to provide real-time optimization of media targeting for digital ads. According to the embodiments disclosed herein, the optimization system 120 includes a category builder to create or update dynamic categories (i.e., create updated dynamic category versions) that are utilized to define category attributes including various category attributes such as, but not limited to, type of page, brand safety and suitability, page signal, keywords in the URL or on the page, time location, and more, through the optimization process.

The dynamic categories created include category attributes that are optimized to allow effective targeted buying (or bidding) for digital ads. More particularly, such category attributes of the dynamic category enable fine tuning of dynamic categories for more accurate media targeting and thus, effective digital ad placement. The category builder may create a first version of a dynamic category based on performance goals (or campaign goals), defined by, for example, an advertising entity, for the specific advertisement.

The optimization system 120 is configured to create and update the dynamic categories based on enriching and analyzing of performance data received from the data collection system 150 as further described herein. The enriched data may include additional layers of data on the raw performance data received. Examples for enriched data points may include, location, weather forecasts based on the location, where the location is determined based on the general location data, and image analyses, such as a description that the webpage specified by the URL includes three pictures of a star player for a national baseball team and the like.

The category matching system 125 is configured to identify ad requests that match the updated (or current) dynamic category version of a targeted dynamic category. The updated dynamic category version including the category attributes are provided to the category matching system 125, for example, iteratively or periodically. In an embodiment, the ad requests identified are provided to the advertiser 140 for targeting the targeted dynamic category. The category matching system 125 is a system, component, device, or the like, that can be part of or separate from the optimization system 120.

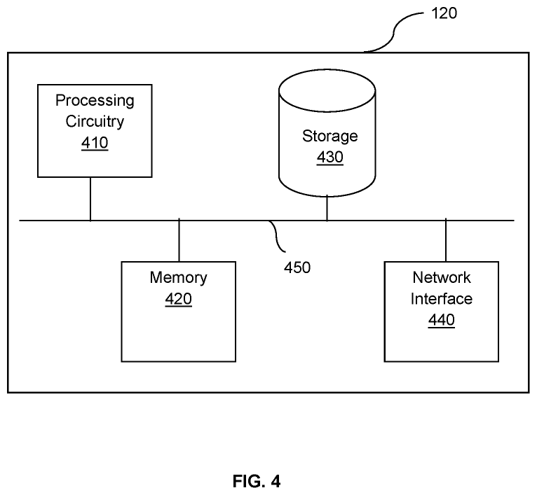

In an embodiment, the optimization system 120 may communicate with the data collection system 150 directly through the network 170 to receive raw performance data of the ad placement such as activity data and respective URL data. In an embodiment, the data collection system 150 is not part of the optimization system 120 and is not controlled by the optimization system 120. In another embodiment, the performance data system 150 may be integrated into the optimization system 120 without departing from the scope of the disclosure. An example of an optimization system 120, according to an embodiment, is described with respect to FIG. 4, below.

Moreover, the optimization system 120 may be communicatively connected to a database 160. The database 160 may include historical data, for example, previously implemented versions of the dynamic category, including category attributes, and/or performance data. In addition, historical category and performance data for similar products and ads may be stored. In further embodiment, the database 160 may include one or more dynamic categories, each including at least one dynamic category version. The one or more dynamic categories may be retrieved and utilized at the exchange platform 130 for targeted media purchasing.

The exchange platform 130 is a system, component, device, or the like, configured to facilitate transactions between advertisers and publishers. In an embodiment, the exchange platform 130 may include data management platform (DMP) and/or supply-side platform (SSP), and/or demand-side platform (DSP). The exchange platform 130 is configured to receive an ad request, including one or more advertisement features from the web server 110, and send over to the advertiser 140. The ad request may include information about the website, such as the URL, and further information about the user accessing the website such as demographic, hobbies, location, and the like. The advertiser 140 makes the decision as to bid on the call for the ad request posted by the exchange platform 130. It may be understood that the exchange platform 130 may be a physical system, a component, device, or the like, a dynamic system, component, device, or the like, or any combination thereof.

In some configurations, the exchange platform 130 may include a real-time bidding (RTB) system (not shown). The RTB system is a system, device, component, or the like, configured to provide real-time bidding functionalities. In such configuration, the RTB system enables auctioning of ad placements in response to the ad request generated by the web server 110, with the category attributes in consideration.

The advertiser 140 is a system, a device, a component, or the like, or any combination thereof, configured to provide advertising bids in response to ad request calls received from the exchange platform 130. In an embodiment, the advertiser 140 makes decisions to bid on ad requests, in varying amounts, in part based on the dynamic category and the category attributes that make up the dynamic category versions created by the optimization system 120. By using the dynamic category provided, the advertisers 140 may be presented with ad requests that match the most currently updated version of the dynamic category for bidding on certain ad impressions for a specific advertisement.

According to an embodiment, the advertiser 140 is presented with ad requests that match the most updated version of the dynamic category created in the optimization system 120 to further improve the bidding of ads, and therefore ad placement as discussed further herein. As noted above, the advertiser 140 may receive one or more matching ad requests as determined by the category matching system 125. In an embodiment, the advertiser 140 may include one or more creatives and/or groups of ads classified according to targeted media. And thus, the advertiser 140 may use different dynamic categories for the different creatives to be separately and distinctively optimized based on the respective dynamic categories. It should be noted that the advertiser 140 is furnished with a dynamic category whose definition is updated dynamically through the selection of category attributes. The dynamic category may include one or more versions that are written and stored in, for example, a memory. In an embodiment, the advertiser 140 targeting a specific dynamic category is presented with ad requests that match the most updated version of the targeted specific dynamic category.

The data collection system 150 is a system, component, device, or the like, or any combination thereof, configured to provide one or more performance data collected from the web server 110 or served web page to the optimization system 120. The performance data may be collected by accepting log level data or by utilizing a tag on the delivered ad, which can provide activity data such as, but not limited to, views, clicks, conversions, impressions, viewability time, and the like, from user engagement and further URL data for the specific ad placement, and more. As noted above, the data collection system 150 communicates with the optimization system 120 over the network 170 to provide raw performance data for enrichment and analysis at the optimization system 120. In an embodiment, the data collection system 150 may be operated by third-party companies.

It may be understood that the various components of the network system described with respect to FIG. 1 may be separately implemented, including in multiple, separate locations, and may be interconnected via one or more networks.

According to the disclosed embodiments, the optimization system 120 is configured to improve media targeting, and thus ad placement and performance, by providing ad requests that match the updated dynamic category version to the advertiser 140 in real-time or near real-time. A dynamic category version including one or more category attributes may be configured within the optimization system 120 to target, modify, and track category attributes that allow improved media targeting for digital ad placements. The optimization for media targeting may include adding one or more category attributes to the next dynamic category version, removing one or more category attributes, and/or modifying data points (such as specific domain targeting or weather, or any other data point). The optimization is performed based on the processing of performance data feedback from the data collection tag. In an example embodiment, the feedback performance data may be provided by a third-party tag on the delivered ad, and optimization of media targeting based on analysis of feedback data may be performed at the optimization system 120. Feedback performance data from the tag may include, but not be limited to, web page URL, app ID, bundle ID, performance metrics like clicks, conversions, views, and the like, and so on, which may be enriched for optimization. It should be understood that feedback performance data may be collected for various digital environments such as, but is not limited to, apps, connected TV, digital out-of-home devices, and more.

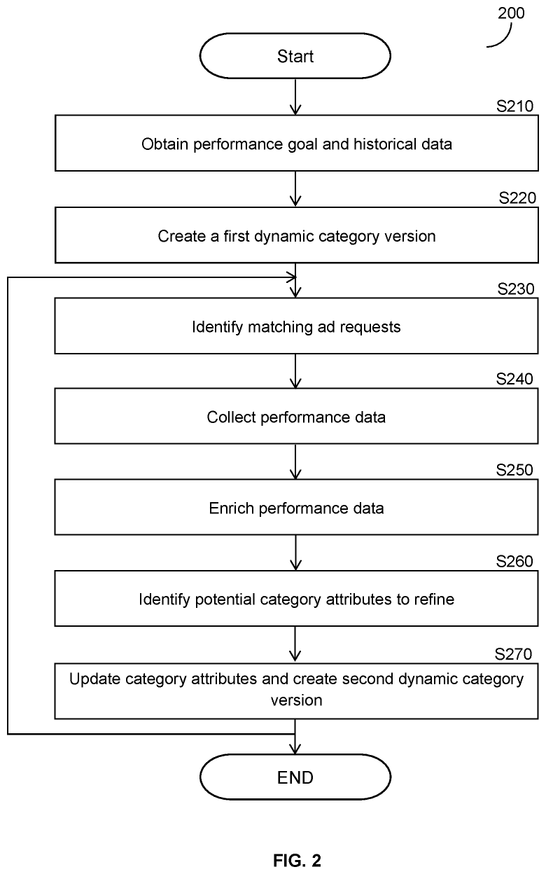

FIG. 2 is an example flowchart 200 illustrating a method for optimizing media targeting for digital advertisements according to an embodiment. The method described herein may be executed by the optimization system 120, FIG. 1.

At S210, a performance goal and/or historical data are obtained. The performance goal (or campaign goal) may be determined by an advertiser (e.g., the advertiser 140, FIG. 1). The historical data may include historical data about an advertisement (or advertising entity) including, but not limited to, campaign goals, dynamic categories including values for category attributes, performance data with respect to dynamic categories, and the like. In an embodiment, each of the category attributes may be data structures that include at least one value (or data) that specifies targeted attributes. As an example, a category attribute of “type of page” may include values such as, but not limited to, web page, mobile application, and the like. In an embodiment, the historical data may be stored in a database (e.g., the database 160, FIG. 1). It should be noted that the campaign goals may be defined using a user device (not shown), for example of an advertising entity, such as, but not limited to, a personal computer, a laptop, a tablet computer, a smartphone, a wearable computing device, or any other device capable of receiving and inputting data.

At S220, a first dynamic category version is created based on the received performance goal and the historical data. In an embodiment, a category builder creates a dynamic category version defined by at least one category attribute. In an embodiment, the first dynamic category version may be empty, i.e., not including any values (null value) with respect to the at least one category attribute. That is, targeting using the empty dynamic category version (i.e., does not include any restriction to specific category attributes) may allow targeting of all ad requests without selectivity. In another embodiment, the first dynamic category version may be created based on historical data and/or default category attributes. A contextual category, such as but not limited to, technology, food, education, sports, and the like, may be initially selected. The contextual category may include one or more subcategories that can be automatically targeted with selection of the contextual category.

The category attributes may include, for example, type of page, brand safety and suitability, page signal, keywords in the page or the URL, time, location, and the like, and any combination thereof. The type of page may include, but is not limited to, webpages, mobile applications (apps), connected TV (CTV), and more. The page signal may suggest the contents of the page, for example, whether the page is content rich, includes product reviews and/or comments, includes strong social signals, and the like. Brand safety and suitability may indicate content related to violence, profanity, and the like, as well as some indication on the level of content quality and relevance. In an embodiment, keywords and boolean logic may be used to include and/or exclude certain keywords in defining the dynamic category. In further embodiment, additional category attributes such as, but not limited to, weather, domain, and the like may be used in the dynamic category for optimized targeting.

As an example, for the same campaign goal, a “finance” contextual category may be selected in one domain, whereas an “education” contextual category may be selected in another domain. As an example, for the same campaign goal, one dynamic category with domain A may include a “finance” contextual category, and another dynamic category with domain B may include an “education” contextual category.

In an embodiment, the first dynamic category version may be labeled and stored for reference and further analysis. In a further embodiment, each version of the dynamic category may be stored with their respective version information for reference and further analysis. In an example embodiment, a unique dynamic category can be created per campaign, ad group, or other type of a group logic. It should be noted that the dynamic category and their versions may be created and employed within the optimization system to track optimization of media targeting, and thus, not conveyed outside of the optimization system (e.g., the optimization system 130, FIG. 1).

At S230, ad requests that match category attributes in the created first dynamic category version are identified. In an embodiment, an ad request is provided to the advertiser (e.g., advertiser 140, FIG. 1) by the exchange platform (e.g., the exchange platform 130, FIG. 1) upon determination that the category attributes of the ad request match that of the first dynamic category version. In such scenario, the advertiser is configured to bid on ad requests on a page that satisfies (or matches) the dynamic category. That is, the advertiser is configured to bid on one or more matching ad requests that are identified based on the first dynamic category version. In an embodiment, a similarity score above a predetermined threshold value may be utilized to determine a matching ad request. It should be noted that only the dynamic categories and the selected ad requests are provided to the advertiser and not the category attributes. The dynamic category is used to hold created category attributes that may be further refined. In an embodiment, the advertiser may select the dynamic category at which media targeting may be directed to.

As noted above in FIG. 1, the exchange platform (e.g., the exchange platform 130, FIG. 1) is configured to receive an ad request generated at the web server (e.g., the web server 110, FIG. 1) and to receive bids on impressions for specific ad placements by the advertiser (e.g., advertiser 140, FIG. 1). That is, the advertisement of the winning bid is delivered and displayed on the specific page by the ad server. In an embodiment, a tag is delivered with the advertisement and deployed on the page to capture activity on the advertisement and further, URL data of the page presenting the winning ad. In an example embodiment, the tag may collect information as to where what, and how interactions were performed on the advertisement on the page. In an example embodiment, the ad delivery including the tag may be performed by a third-party company.

At S240, in response to serving the ad on a page, performance data is collected from the data collection system. The data collection system may collect raw performance data of the ad from a tag deployed with the ad on the page. It should be noted that the raw performance data is not aggregated or altered at the data collection system, but directly passed onto the optimization system (e.g., the optimization system 120). The raw performance data may include, for example, and without limitation, click data, view data, conversion indicator, impressions, and the like. As an example, the tag may capture user interactions on the page and/or the ad such as scrolling, hovering, clicking on certain areas, or the like. In an embodiment, the raw performance data may include URL data of the page, such as, but not limited to, type of page, page content, quality, safety, time and location of a user request to access page, and more.

It should also be noted that the raw performance data may not include user-based attributes such as, but not limited to, user demographics, that may be provided during ad requests. It should be further emphasized that, in contrast to disclosed herein, the collected performance data in conventional techniques are aggregated from multiple ads, and typically are not associated with a unique identification related to a specific ad or a specific URL (page) that an ad was served.

At S250, the collected performance data is enriched. In an embodiment, the optimization system may be configured to generate enriched data based on the collected performance data. In an embodiment, the collected performance data can be enriched by associating the performance data with a URL (page), category attributes of the ad, or both. The enriched data may include an additional layer of data providing additional descriptions related to the collected performance data. For example, if raw performance data is the location data of the page presenting the ad, then the enriched performance data may be weather information at that location. In another example, if the raw performance data is an interaction with an image on the page, then the enriched data point may be a description of the image (e.g., homes).

At S260, potential category attributes to refine in the first dynamic category version are identified. At least portions of the first dynamic category version may be modified based on the analysis of the enriched performance data from feedback performance data received from the tag delivered and deployed with the ad placement on the page. In an embodiment, analysis may be performed by applying at least one algorithm, such as an advanced machine learning algorithm, or a reinforcement learning algorithm, on the feedback data including the enriched performance data, current and prior dynamic category versions, and more.

The category attributes in the first dynamic category version may be matched with the URL data, and further analysis may be performed using activity data on the delivered ad. In an embodiment, feedback performance data from ad placement based on different versions of the dynamic category may be compared to identify which category attributed to modify, for example, as a result of NB testing. In an example embodiment, each category attribute may be analyzed to determine the effectiveness of the implemented category attributes and associated values. And thus, potential category attributes may be selected for further analyses. In another embodiment, potential category attributes may be randomly selected and implemented. It should be noted that a balance between exploration and exploitation is desired when selecting and suggesting potential category attributes for modification of the dynamic category version.

In an embodiment, potential category attributes may be identified with different objectives such as, but not limited to, clicks, impressions, conversions, viewability, cost, or the like, or any combination thereof. That is, potential category attributes may differ depending on the objective of focus. As an example, when high viewability is the objective, a type of page with high viewability may be selected despite risking the quality of the page to which the ad is delivered. In another example, when cost efficiency is the objective, a contextual category such as food, which may be lower in advertising cost than other contextual categories using the same keyword, and a single value for page signal may be selected as potential category attributes. In a further embodiment, potential attributes may be selected with respect to different campaign goals and/or performance goals.

It should be noted that even with different objectives in focus, the potential category attributes are identified to improve advertisement efficiency and to meet performance goals. In an embodiment, enriched data may be reorganized for reporting based on different parameters such as, but not limited to, URL, domain, performance metrics, category attributes, and the like. In another embodiment, pre-bid and post-bid data and category attributes may be matched to identify potential category attributes for improved targeting. In an embodiment, the identified potential category attributes may be output as suggestions for the next step.

At S270, the category attributes of the first dynamic category version are updated to generate at least one second dynamic category version. The second dynamic category version may be generated based on identified potential category attributes from the first dynamic category version. In an embodiment, the dynamic category version may be updated by adding and/or removing particular category attributes such as, type of page, brand safety, and suitability, page signal, quality, rules, keywords on the page or in URL, time of day, location, or the like, or any combinations thereof. In a further embodiment, one or more second dynamic category versions may be stored in, for example, a memory, for future analysis and reference. Each of the stored dynamic category versions may include respective information such as, but not limited to, version identifier, category attributes, modifications from prior version, associated feedback data, and more. In an embodiment, the generated second dynamic category version may be retrieved from prior versions of the dynamic category that have been determined as effective media targeting for the performance goal (i.e., exploitation).

In an embodiment, updating the category attributes of the dynamic category to create dynamic category versions may be performed at custom time intervals for media targeting or ad placement. The time interval may be customized based on volumes, such as but not limited to, impressions, clicks, conversions, and the like. In further embodiment, the optimization system may be configured with a cold start optimization operation to minimize cold start problems and reduce inefficiencies in processing.

The operation returns to S230 so that the updated category attributes in the second dynamic category version are utilized to determine new matching ad requests. The new matching ad requests are ad requests that include category attributes substantially similar to that of the updated second dynamic category version. In an embodiment, the updated category attributes and their respective dynamic category versions are used to improve targeted media purchasing (i.e., bidding of ad impressions) by selectively providing matching ad requests to an advertiser (e.g., the advertiser 140, FIG. 1). The operation iteratively continues through the loop process (S230 through S270) outlined in FIG. 2 to continuously update the category attributes of the dynamic category in real-time to optimize media targeting with respect to the performance goal and create additional versions of the dynamic category (third, fourth, etc.). As noted above, the dynamic category versions are created and utilized within the optimization system and the category matching system 125 not transferred externally to, for example, the advertiser. And thus, the advertiser is only aware of the dynamic category (or its identifier, such as a dynamic category name, ID, and the like) that the advertiser is targeting and receives the ad requests selected for the targeted dynamic category as determined within the category matching system 125 based on the dynamic category versions.

The optimization may be performed as long as the campaign is active, during a predefined time period (e.g., minutes, hours, day, a week, and the like), and so on. In an embodiment, the optimization of the media targeting through the loop operation (S230 to S270) may continue until the campaign goal for the specific ad is achieved. In an embodiment, the operation may terminate after S270 when the performance goal (or campaign goal) is met above a predetermined threshold value. In an embodiment, the achievement of the performance goal may be determined based on analysis of at least a portion of the performance data received in response to serving the ad on the page. In an embodiment, the category attributes in the dynamic category may not be further updated when a performance goal is achieved. In another embodiment, the category attributes in the dynamic category may not be further updated when feedback performance data does not improve above a predefined threshold.

It should be appreciated that the method of FIG. 2 may be automatically performed without requiring manual intervention. Furthermore, the updating and optimization of media targeting may be performed within a fraction of a second to adequately serve the advertisement to a user, for example, through the web server (e.g., web server 110, FIG. 1).

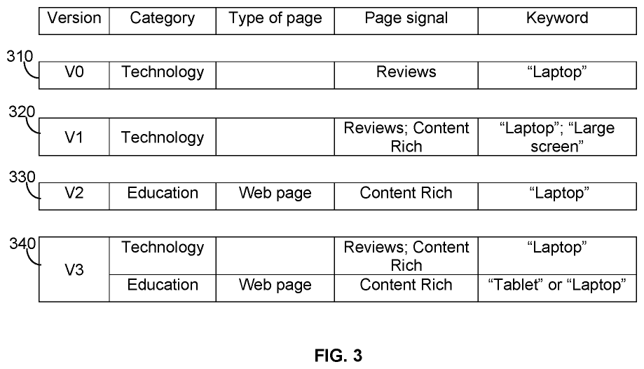

FIG. 3 is an example schematic diagram illustrating a method for creating dynamic category versions and updating respective category attributes for optimized media targeting according to an example embodiment. Each of the dynamic category versions are different (or updated) versions of a single dynamic category that can all be identified using a same dynamic category name and ID for implementation at the advertiser (e.g., the advertiser 140, FIG. 1). Example dynamic category versions 310 through 340 are iteratively generated by identified category attributes according to the process outlined in FIG. 2. Each dynamic category version includes a version label, example category attributes (contextual category, type of page, page signal, keywords), and values for each of the category attributes. Identification of potential category attributes and generation of the different dynamic category versions may be performed at the optimization system (e.g., the optimization system 120, FIG. 1) as disclosed above.

As an example, an advertiser seeks ad placement for a laptop computer. A first dynamic category version 310 is created based on the advertiser's campaign goals and historical data for similar products and/or the advertiser's product. To this end, the first dynamic category version 310, labeled as version 0 (V0), is selected to be in the “technology” contextual category with a page signal attribute of “reviews” and a keyword “laptop.” In the same examples, with respect to the disclosed embodiments, enriched performance data may indicate high conversion rate from a page dense in text (i.e., Content Rich) and a keyword of “large screen”. In this scenario, the page signal and keyword may be identified as potential category attributes to update to generate a new dynamic category version 320, now labeled as version 1 (V1).

According to the same example, the updated category attributes in the dynamic category version 320 (V1) may be provided to a category matching system (the category matching system 125, FIG. 1) to change the definition of the dynamic category for the advertiser (e.g., the advertiser 140, FIG. 1) to bid on an ad placement that satisfy the dynamic category. Moreover, feedback performance data from the tag deployed with the advertisement on a page may suggest further updating of category attributes in the dynamic category version 320 (V1). Here, potential category attributes may be identified with cost-efficiency as the objective to reduce advertising costs for maximum advertising effectiveness. In this scenario, the “education” contextual category, which costs less for advertising using the “laptop” keyword, may be identified to generate a new dynamic category version 330 (V2) to target media that is in the “education” category and presented in web browsers with “Content Rich” page signal, and the keyword “laptop.”

In furtherance to the above example and the disclosed embodiments, another dynamic category version 340 (V3) may be generated by adding and/or removing identified potential attributes and corresponding values. In this example, both contextual categories of “technology” and “education” are selected for optimized media targeting of ad placement. Such updating of category attributes and generating of dynamic categories may be continuously performed according to the disclosed embodiments to optimize and effectively target media for ad placement. As noted above, each dynamic category version may be stored including values and modifications to the category attributes as well as versions and feedback data of category attributes.

It should be noted that the category attributes are updated and thus, dynamic category versions are created in the optimization system (e.g., the optimization system 120, FIG. 1). The advertiser is exposed only to the dynamic category, which is used to bid and purchase ad impressions, without being exposed to the different category versions and/or the category attributes. The dynamic category including, but not limited to, version, category attributes, performance data, and any combination thereof, may be stored in a memory within the optimization system or a database (e.g., the database 160, FIG. 1). It should be noted that more than one dynamic category is available for the optimization system in order to allow targeted media purchasing based on different dynamic categories. That is, the embodiment disclosed herein may be applied to distinct dynamic categories, which can be separately and simultaneously optimized. It should be understood that example embodiments herein are only for illustrative purposes and does not limit the scope of the present disclosure.

FIG. 4 is an example schematic diagram of an optimization system 120, according to an embodiment. The optimization system 120 includes a processing circuitry 410 coupled to a memory 420, a storage 430, and a network interface 440. In an embodiment, the components of the optimization system 120 may be communicatively connected via a bus 450. In an embodiment, the optimization system 120 and the category matching system 125 may be configured together in a single component, device, server, and the like. Further, the category matching system 125 may be structured to include the elements shown in FIG. 4.

The processing circuitry 410 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or another memory technology, compact disk-read only memory (CD-ROM), Digital Versatile Disks (DVDs), or any other medium which can be used to store the desired information.

The network interface 440 allows the optimization system 120 to communicate with the various components, devices, and systems described herein for enriching bid requests for real-time bidding, as well as other, like, purposes.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

1. A method for optimizing media targeting for placement of digital advertisements:
creating, based on a performance goal and historical data, a first dynamic category version, wherein the first dynamic category version includes at least one category attribute;
identifying at least one first matching advertisement (ad) request based on the first dynamic category version, wherein the at least one first matching ad request is determined by matching the category attributes of the first dynamic category version and category attributes of the at least one first ad request, wherein the at least one first matching ad request is bid on for the placement of advertisements;
in response to the placement of advertisements, gathering feedback data on performance of served advertisements, wherein the feedback data is gathered with respect to each of the served advertisements;
identifying, based on the gathered feedback data, at least one potential category attribute;
updating the first dynamic category version to create a second dynamic category version based on a portion of the identified at least one potential category attribute;
identifying at least one second matching ad request for bidding, wherein the at least one second matching ad request is determined based on the second dynamic category version, wherein the at least one second matching ad request is bid on for placement of the advertisements; and
iteratively creating third dynamic category versions from a previous dynamic category version until the goal is substantially met.

2. (canceled)

3. The method of claim 1, further comprising:
attaching a tag to each advertisement for the placement; and
enriching the gathered feedback data to add additional descriptions related to the performance of the each of the served advertisements.

4. The method of claim 1, wherein the feedback data includes at least one of: a uniform resource locator (URL) of an ad placement webpage, URL data, application identification (ID), bundle ID, and performance data.

5. The method of claim 4, wherein the performance data includes at least one of: a number of views, a number of clicks, a number of conversions, and a number of impressions.

6. The method of claim 1, wherein a machine learning model trained to identify the at least one potential category attribute is derived from feedback data.

7. The method of claim 3, wherein identifying the at least one potential category attributes further comprises:
extracting category attributes and values from the first dynamic category version; and
determining performance data for each of the extracted category attributes, wherein the performance data are enriched performance data of the enriched feedback data.

8. The method of claim 1, wherein identifying the at least one potential category attributes:
is based on an objective for optimizing.

9. The method of claim 1, wherein each version of the dynamic category is saved in a memory, each saved version includes at least one of: a version identifier, a version name, category attributes, modification information, and feedback data.

10. A non-transitory computer readable medium having stored thereon instructions for causing a processing circuitry to execute a process, the process comprising:
creating, based on a performance goal and historical data, a first dynamic category version, wherein the first dynamic category version includes at least one category attribute;
identifying at least one first matching advertisement (ad) request based on the first dynamic category version, wherein the at least one first matching ad request is determined by matching the category attributes of the first dynamic category version and category attributes of the at least one first ad request, wherein the at least one first matching ad request is bid on for the placement of advertisements;
in response to the placement of advertisements, gathering feedback data on performance of served advertisements, wherein the feedback data is gathered with respect to each of the served advertisements;
identifying, based on the gathered feedback data, at least one potential category attribute;
updating the first dynamic category version to create a second dynamic category version based on a portion of the identified at least one potential category attribute;
identifying at least one second matching ad request for bidding, wherein the at least one second matching ad request is determined based on the second dynamic category version, wherein the at least one second matching ad request is bid on for placement of the advertisements; and
iteratively creating third dynamic category versions from a previous dynamic category version until the goal is substantially met.

11. A system for optimizing media targeting for placement of digital advertisements, comprising:
a processing circuitry; and
a memory, the memory containing instructions that, when executed by the processing circuitry, configure the system to:
create, based on a performance goal and historical data, a first dynamic category version, wherein the first dynamic category version includes at least one category attribute;
identify at least one first matching advertisement (ad) request based on the first dynamic category version, wherein the at least one first matching ad request is determined by matching the category attributes of the first dynamic category version and category attributes of the at least one first ad request, wherein the at least one first matching ad request is bid on for the placement of advertisements;
in response to the placement of advertisements, gather feedback data on performance of served advertisements, wherein the feedback data is gathered with respect to each of the served advertisements;
identify, based on the gathered feedback data, at least one potential category attribute;
update the first dynamic category version to create a second dynamic category version based on a portion of the identified at least one potential category attribute;
identify at least one second matching ad request for bidding, wherein the at least one second matching ad request is determined based on the second dynamic category version, wherein the at least one second matching ad request is bid on for placement of the advertisements; and
iteratively create third dynamic category versions from a previous dynamic category version until the goal is substantially met.

12. (canceled)

13. The system of claim 11, wherein the system is further configured to:
attach a tag to each advertisement for the placement; and
enrich the gathered feedback data to add additional descriptions related to the performance of the each of the served advertisements.

14. The system of claim 11, wherein the feedback data includes at least one of: a uniform resource locator (URL) of an ad placement webpage, URL data, application identification (ID), bundle ID, and performance data.

15. The system of claim 14, wherein the performance data includes at least a number of views, a number of clicks, a number of conversions, and a number of impressions.

16. The system of claim 11, wherein a machine learning model trained to identify the at least one potential category attribute is derived from the feedback data.

17. The system of claim 13, wherein the system is further configured to:
extract category attributes and values from the first dynamic category version; and
determine performance data for each of the extracted category attributes, wherein the performance data are enriched performance data of the enriched feedback data.

18. The system of claim 11, wherein identifying the at least one potential category attributes is based on an objective for optimizing.

19. The system of claim 11, wherein each version of the dynamic category is saved in a memory, each saved version includes at least one of: a version identifier, a version name, category attributes, modification information, and feedback data.

20. The method of claim 3, wherein enriching further comprises:
associating gathered feedback data with at least one of: a page and the category attributes.
